(19) United States
(12) Patent Application Publication
(10) Pub. No.: US 2017/0284585 A1
(43) Pub. Date: Oct. 5, 2017

(54) PIPE CLAMP

(71) Applicant: Georg Fischer Wavin AG, Schaffhausen (CH)

(72) Inventors: Joerg HUNNEKUHL, Jestetten (DE); Markus BREYER, Radolfzell (DE); Juergen ROESCH, Lenzkirch (DE)

(21) Appl. No.: 15/513,895

(22) PCT Filed: Sep. 9, 2015
(86) PCT No.: PCT/EP2015/070552

§ 371 Date: Mar. 23, 2017

(30) Foreign Application Priority Data
Sep. 26, 2014 (EP) 14186494.2

(51) Int. Cl. F16L 47/34

(52) U.S. Cl. CPC F16L 47/345

(57) ABSTRACT

The invention relates to a pipe clamp, in particular an electric welding pipe clamp which can be mounted around a plastics pipeline, containing a saddle element having a connecting piece for a tapping unit or for the connection of an outgoing pipeline, straps to wrap around the pipeline, strap ends, wherein the strap ends have latching means, at least one latching area, wherein the strap ends are latched in in the latching area in order to fix the pipe clamp to the plastics pipeline, wherein the latching area has a tensioning element, wherein the tensioning element is arranged such that the tensioning element can be slid into a tensioning element groove.

### CROSS-REFERENCE TO RELATED APPLICATIONS

This application is a National Stage of International Application No. PCT/EP2015/070552, filed on Sep. 9, 2015, and published in German as WO 2016/045964 A1 on Mar. 31, 2016. This application claims the priority to European Patent Application No. 14186494.2, filed on Sep. 26, 2014. The entire disclosures of the above applications are incorporated herein by reference.

### FIELD

The disclosure relates to a pipe clamp, in particular an electric welding pipe clamp, which can be fitted around a plastics pipeline, containing a saddle element having a connecting piece for a tapping unit or for the connection of an outgoing pipeline, straps for wrapping around the pipeline, strap ends, wherein the strap ends have latching means, at least one latching region, wherein the latching means of the strap ends are latched in the latching region in order to fasten the pipe clamp to the plastics pipeline.

### BACKGROUND

Pipe clamps of this type are known from the prior art. They can be used as tapping clamps and can be fastened to gas or water pipelines, in which, by means of a tapping fitting, they drill through the wall, wherein the connecting piece can serve for the reception of a tapping unit. Moreover, such pipe clamps can also however be used for the mere connection of branch pipes or other fittings, as can a combined version of a tapping fitting, which, after the tapping, is suitable for the connection of a branch pipe or a further fitting.

U.S. Pat. No. 7,219,684 B2 discloses a connecting saddle, which is fastened around the pipe by an integrated strap. The strap latches to a closing unit, whereby the pipe clamp is fastened to the pipe.

U.S. Pat. No. 6,767,033 B2 likewise discloses a connecting saddle for the connection of a branch line. The connecting saddle has an integrated strap, which is reinforced at the end and has latching teeth. In this connecting saddle too, the strap is received in a locking mechanism, wherein the locking mechanism, as well as the strap, has ribs in order to exert a pressure on the strap so that it does not detach itself from the locking mechanism.

The abovementioned connecting saddles have the drawback that they do not autonomously retension themselves. That is to say that, if the tension in the strap diminishes, the connecting saddle no longer sits firmly on the pipe or it has to be manually retensioned.

EP 1 191 274 B1 likewise discloses a pipe clamp, wherein this is formed of a top part and bottom part and is connected on one side by means of hinge. On the opposite side, the pipe clamp is clamped together by means of screws and fixed to the pipe.

A drawback with this pipe clamp is that it likewise has to be manually retensioned and that it requires a tool for the assembly, as well as for the manual retensioning.

### SUMMARY

The object of the disclosure is to propose a pipe clamp which, for fastening to the pipelines, requires no tool, and to propose that it is also constantly firmly fixed to the pipeline without the need for a manual readjustment.

This object is achieved according to the disclosure by virtue of the fact that the latching region has a tensioning element, wherein the tensioning element is arranged slidably in a tensioning element groove.

The saddle element of the pipe clamp according to the disclosure has a latching region, which contains a tensioning element groove. This tensioning element groove extends preferably over the length of the saddle element, thus parallelly to the center axis of the pipe clamp or of the plastics pipeline on which the pipe clamp is fitted. The tensioning element groove is configured such that the tensioning element can be arranged therein. The tensioning element is arranged in a positive-locking manner in the tensioning element groove and is displaceable in the tensioning element groove, roughly tangentially to the pipeline circumference.

For the fastening of the pipe clamp to the pipeline, the strap ends are latched in the tensioning element. This is realized in that the strap ends are pushed through an opening or cutout (a plurality of openings also being conceivable) in the floor of the tensioning element groove and are latched in the tensioning element, which is arranged slidably in the tensioning element groove. Since the tensioning element is arranged slidably in the tensioning element groove, the strap can be further readjusted, or the tensioning element retensions the strap independently, in that a force acts on the tensioning element and the strap or straps are thereby constantly tensioned. This has the advantage that, due to, for instance, a stretching of the straps or some other alteration of the pipe clamp, which is preferably made of plastic, no manual retensioning is necessary, nor does the pipe clamp become detached, since it retensions itself autonomously as a result of the slidable tensioning element and of the force itself which constantly acts thereon. In electric welding clamps too, this is a great advantage, since a welding pressure builds up in the course of the welding operation and an expansion of the saddle is thereby discernible. In this way, these geometric and pressure-generated differences can be compensated by means of the tensioning element.

That force which in the latching region is exerted on the tensioning element is preferably realized by at least one spring element, a plurality of spring elements also being conceivable and the embodiment comprising two spring elements being favorable. Preferably, two compression springs are arranged side by side in the tensioning element groove, which act on the tensioning element and push this up. This in turn causes a pull on the straps, which are latched in the tensioning element and are thereby constantly tightened.

Preferably, the spring elements are guided by guides. For the sake of simplicity, the tensioning element groove has two guide pins fixedly arranged therein and, in the tensioning element, two corresponding guide bores, in which the compression springs are disposed and the pins likewise serve as an inner guide.

To prevent the tensioning element from inadvertently springing out of the tensioning element groove if the straps are not yet latched, the tensioning element has a locking device, which is preferably arranged as a type of pin or extension on the tensioning element and passes through a continuous cutout or opening in the floor of the tensioning element groove and is stopped by means of the stopping element on the pin or the extension, which stopping element is preferably configured as a barb, springing-out is rendered impossible and the tensioning element is stopped.

In order that the pipe clamp or the retensioning of the tensioning element is only activated once the pipe clamp is fitted, since the straps must be latched in the tensioning element, the pipe clamp has a locking pin, which is stuck through the aforementioned locking device of the tensioning element, wherein the locking device of the tensioning element has for this purpose an appropriate bore, and the locking pin, by abutting the latching region, prevents the tensioning operation of the tensioning element. If the locking pin is removed, the force of the spring elements acts on the tensioning element, pushes said element up and thereby tautens the straps, which are latched in the tensioning element.

The tensioning element has unlocking tongues. These serve to re-release the strap end, which is latched for fitting on the tensioning element, in order to remove the pipe clamp from the pipe, where necessary and if not welded to the pipe.

On the unlocking tongues are likewise arranged latching means, which are preferably configured as latching teeth. For the fastening of the strap or strap ends, the latching elements of the strap ends, and those of the tensioning element or those on the unlocking tongues, interlock.

The strap ends are guided in the tensioning element in such a way that they must hook into the latching elements of the unlocking tongues and a release is only possible if the unlocking tongues are actuated such that the latching elements can detach from one another.

A preferred embodiment consists in the pipe clamp having a saddle element and straps which are configured in one piece. That is to say that the straps preferably extend from one side of the saddle element or are directly molded on, for instance as a result of manufacture by means of injection molding, and can then be latched in the latching region on the other side of the saddle element.

An alternative embodiment of an apparatus according to the disclosure has on both sides of the saddle element a latching region running parallel to the center axis, in which latching regions a tensioning element is respectively arranged in the corresponding tensioning element groove. In such an embodiment of the apparatus according to the disclosure, the straps are not molded directly onto the saddle element, but are separately configured parts, whether it be an individual strap, or a plurality of individual straps which can be connected with a crosspiece, or not. By means of the two latching regions in which the straps are clamped, the pipe clamp is fastened to the pipeline. The tensioning operation now takes place on both sides. Specifically in the case of larger dimensions, this variant is preferable.

Preferably, the pipe clamp has a plurality of straps which run in parallel, though just one strap would also be imaginable.

In the case of a plurality of parallelly extending straps, it is advantageous if these are connected to one another by means of a crosspiece. This also makes it possible for three straps, for instance, to extend from the saddle element and to be connected at the end by means of a crosspiece and then merge into two strap ends.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

An illustrative embodiment of the disclosure is described with reference to the figures, though the disclosure is not limited only to the illustrative embodiment, wherein:

FIG. 1 shows a three-dimensional representation of a pipe clamp according to the disclosure, having a latching region,

FIG. 2 shows a partial section of a pipe clamp according to the disclosure in the latching region,

FIG. 3 shows an exploded representation of a pipe clamp according to the disclosure,

FIG. 4 shows a partial section of a pipe clamp according to the disclosure through the spring elements,

FIG. 5 shows a three-dimensional representation of a pipe clamp according to the disclosure, having two latching regions.

Corresponding reference numerals indicate corresponding parts throughout the several views of the drawings.

### DETAILED DESCRIPTION

Example embodiments will now be described more fully with reference to the accompanying drawings.

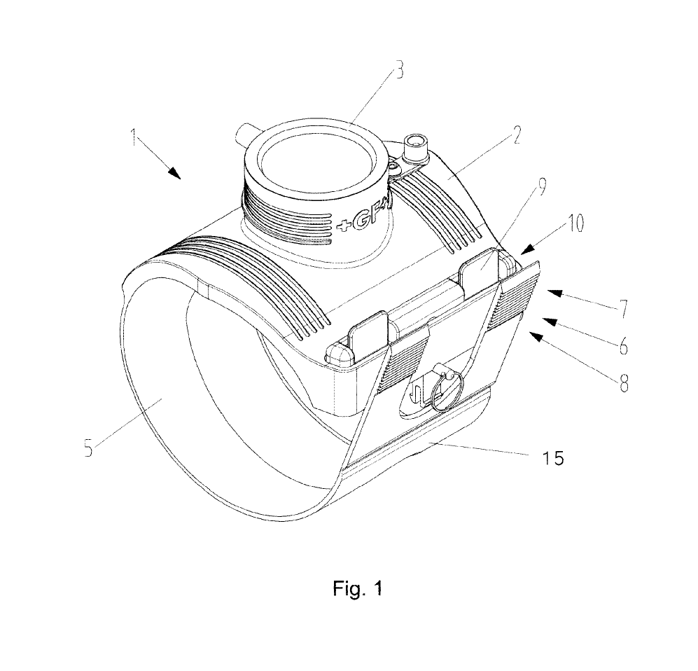

FIG. 1 shows a pipe clamp 1 according to the disclosure, wherein the straps 5 are not yet latched in the latching region 7 for fitting on a pipeline. That embodiment of the pipe clamp 1 according to the disclosure which is represented in FIG. 1 shows a latching region 7, which is arranged on one side of the saddle element 2, and the straps 5, which are molded onto the saddle element 2, so that the saddle element 2 and the straps 5 are in one piece. Preferably, the pipe clamp 1 according to the disclosure is an electric welding pipe clamp, as also demonstrated in the illustrative embodiments, though the pipe clamp 1 according to the disclosure can also be adopted in pipe clamps which are not configured as an electric welding pipe clamp. The present pipe clamp 1 has a saddle element 2, on which is arranged a connecting piece 3 for the connection, for instance, of an outgoing pipeline. The pipe clamp 1 has straps 5 for wrapping around a plastics pipeline (not represented). Preferably, the pipe clamp 1 has a plurality of straps 5, which run in parallel. Of course, a version having just one strap would also be conceivable, in which case this would be made wider. In the illustrative embodiment there are arranged two parallelly running straps 5, which are configured in one piece with the saddle element 2. Moreover, they are connected to one another via a crosspiece 15 and then extend further into two strap ends 8, which serve for the fastening of the pipe clamp 1 or for the fastening in the tensioning element 9. By all means, differently configured straps which have no crosspiece 15, for instance, can also be used.

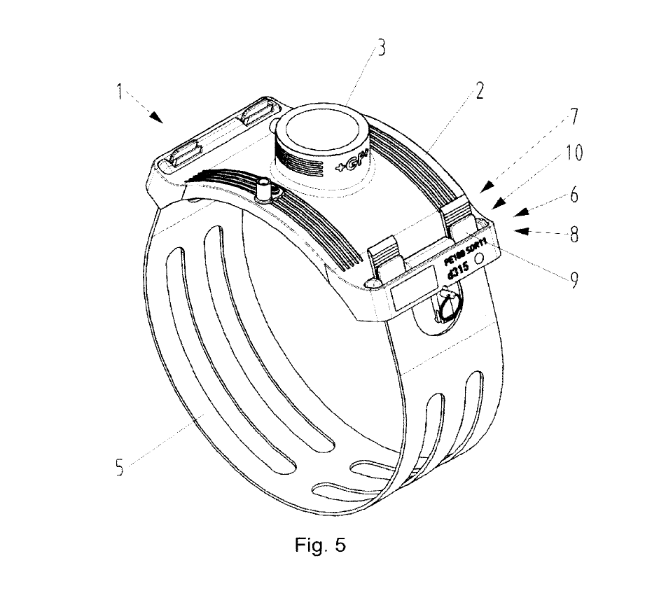

Preferably, the saddle element 2, the straps 5, the crosspiece 15 and the strap ends 8 are configured in one piece, that it to say that, for instance by injection molding, a one-piece manufacture can be realized and hence low manufacturing costs are incurred. Of course, a multipart version is also conceivable, while a different design of the straps 5, of the crosspiece 15 and of the strap ends 8 is also imaginable. In a multipart variant as is represented in FIG. 5, the saddle element 2 has on both sides a latching region 7, which latching regions run parallel to the center axis and extend preferably over the length of the saddle element 2. In this embodiment, the straps 5 are configured as separate parts and are not molded directly onto the saddle element 5. The straps 5, whether with or without a crosspiece 15 which connects them, are latched with their strap ends 8 and their latching means 6 in the tensioning elements 9 in the latching regions 7. Upon the release of the locking pins 13, the tensioning elements 9 are respectively activated on both sides and a bilateral tensioning of the straps 5 takes place.

The strap ends 8 have latching means 6, which serve for the latching of the straps 5 in the latching region 7 and thereby fix the pipe clamp 1 to the plastics pipe. In the embodiment depicted in FIG. 1, the latching region 7 is disposed on one side of the saddle element 2 and runs along the center axis of the pipe clamp 1 or of the plastics pipeline, onto which the pipe clamp 1 is fitted.

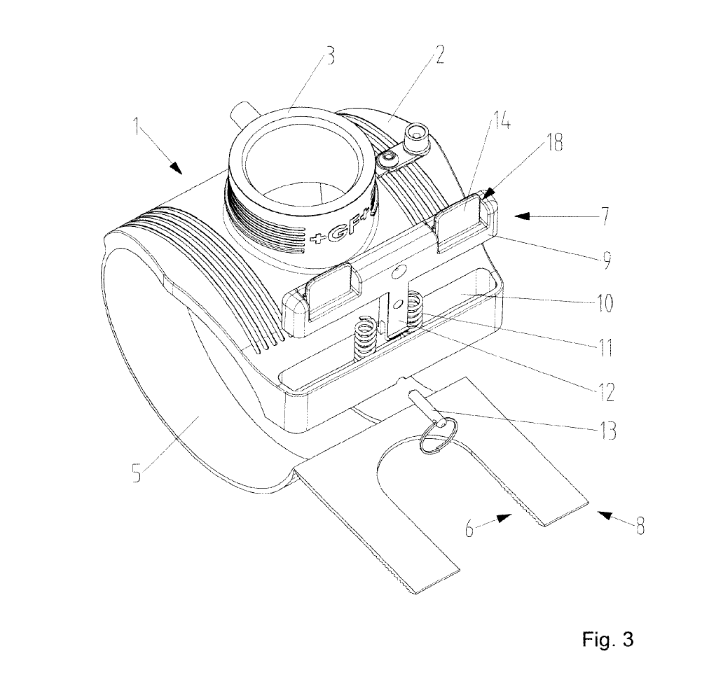

The latching region 7 has a tensioning element groove 10, in which the tensioning element 9 is displaceably arranged. That is to say, the tensioning element 9 cannot be displaced along the center axis of the plastics pipeline, but roughly tangentially to the plastics pipeline circumference, so that the tensioning element 9 can be slid out of the tensioning element groove 10, as is evident in FIG. 3.

The tensioning element 9 extends over the entire length of the tensioning element groove 10 or over the length of the pipe clamp 1. Beneath the tensioning element 9 or on the floor of the tensioning element groove 10 are arranged spring elements 11, preferably compression springs, which push up the tensioning element 9. The strap ends 8 are then pushed through the floor of the tensioning element groove 10, which floor has cutouts 4, and latched in the tensioning element 9 by means of the latching means 6 on the strap ends 8. By the spring elements 11, which push up the tensioning element 9, the straps 5 are tensioned once the locking pin 13 is pulled and the pipe clamp 1 is thereby activated. This means that the pipe clamp 1 is placed around the plastics pipe, the strap ends 8 are latched into the tensioning element 9, and the locking pin 13, which is disposed in the locking device 12 of the tensioning element 9, is pulled and the straps 5 are thereby tensioned still further. Moreover, the pipe clamp 1 according to the disclosure has the advantage that it constantly keeps itself tensioned, and also retensions itself. This is also advantageous in an electric welding pipe clamp in which, during the welding, a welding pressure is built up and an expansion of the saddle 2 is discernible, whereby the geometric and press-generated differences are compensated by the tensioning element 9 and in this way the tensioning element 9 maintains the tension by retightening of the straps 5.

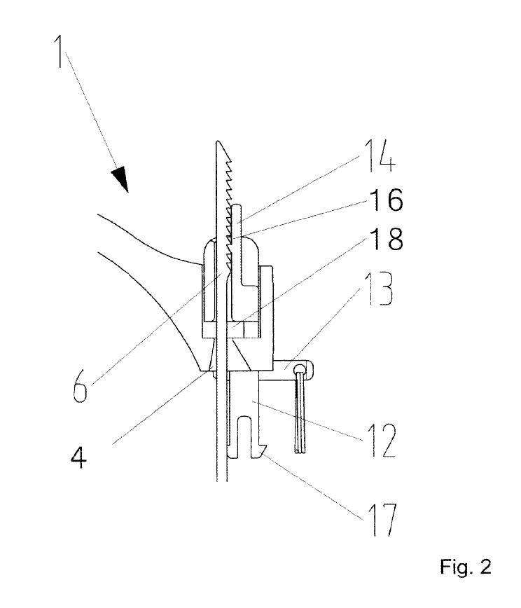

To prevent the tensioning element 9 from inadvertently springing out of the tensioning element groove 10, for instance in the event of accidental pulling of the locking pin 13, the tensioning element 9 has a locking device 12 which prevents this. In this embodiment, the locking device 12 is configured as a type as pin, which is directly arranged on the tensioning element 9. The locking device 12 has stopping elements 17, which are here configured as barbs on the lower region and abut the rim of the opening or cutout 4 in the floor of the tensioning element groove 10 when the tensioning element 9 lifts too far, since the opening is of such a size that the locking device 12 can only pass through when the stopping elements 17 are compressed, as is evident in FIG. 2. Furthermore, in FIG. 2 it can clearly be seen how the latching means 6 of the strap ends 8 engage in the latching means 16 on the tensioning element 9 or on the unlocking tongues 14. Preferably, the latching means 6, 16 are configured as teeth, and preferably more than just one tooth is arranged on the unlocking tongues 14. In FIG. 2, the locking operation can clearly be seen. The strap ends 8 are pushed through the grooves 18 on the tensioning element 9 and, at the same time, guide the strap ends 8.

An unlocking is only possible if the unlocking tongues 14 are pressed rearward in order that the latching means 6 of the strap ends 8 are no longer in engagement with the latching means 16 of the unlocking tongues 14.

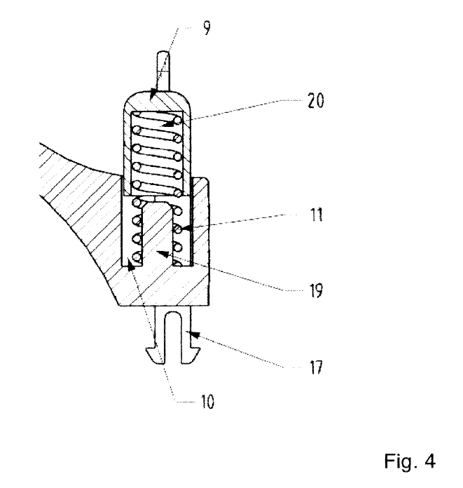

It has proved to be a further advantage that if the spring elements 1 are guided, preferably as in the shown embodiment, on guide pins 19 and guide bores 20 in the tensioning element 9, which are fixedly arranged in the tensioning element groove 10 and in which the spring elements 11 are received and guided, as is represented in FIG. 4.

FIG. 3 shows the pipe clamp 11 according to the disclosure in an exploded view. It can thereby clearly be seen in what direction the tensioning element 9 can be displaced or in what direction it shifts when the locking pin 13 is pulled and the pipe clamp 1 or the latching region 7 is activated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A pipe clamp, in particular an electric welding pipe clamp, which can be fitted around a plastics pipeline, said pipe clamp comprising a saddle element having a connecting piece for a tapping unit or for the connection of an outgoing pipeline, straps for wrapping around the pipeline, strap ends, wherein the strap ends have latching means, at least one latching region, wherein, for the fastening of the pipe clamp to the plastics pipeline, the latching means of the strap ends are latched in the latching region, and wherein the latching region has a tensioning element, wherein the tensioning element is arranged slidably in a tensioning element groove.

2. The pipe clamp as claimed in claim 1, wherein the latching region has at least one spring element, wherein the spring element exerts a force on the tensioning element and the straps are thereby constantly tensioned or continuously retensioned.

3. The pipe clamp as claimed in claim 1, wherein the tensioning element has a locking device, wherein the locking device prevents the tensioning element from inadvertently springing out of the tensioning element groove.

4. The pipe clamp as claimed in claim 1, wherein the pipe clamp has a locking pin, wherein the removal of the locking pin releases the force of the spring element onto the tensioning element.

5. The pipe clamp as claimed in claim 1, wherein the tensioning element has unlocking tongues.

6. The pipe clamp as claimed in claim 1, wherein the saddle element and the straps are configured in one piece.

7. The pipe clamp as claimed in claim 1, wherein the pipe clamp has a latching region, which is arranged on one side of the saddle element and runs parallel to the center axis.

8. The pipe clamp as claimed in claim 1, wherein the saddle element has two latching regions, which are arranged on both sides of the saddle element and run parallel to the center axis.

9. The pipe clamp as claimed in claim 1, wherein the straps are mutually connected with a crosspiece.

10. The pipe clamp as claimed in claim 1, wherein the unlocking tongues have latching means.
